(19) United States
(12) Patent Application Publication
(10) Pub. No.: US 2025/0326673 A1
(43) Pub. Date: Oct. 23, 2025

(54) ASPHERICAL PRISM AND PREPARATION METHOD THEREOF

(71) Applicant: AAC Optics (Chongqing) Co., Ltd., Chongqing (CN)

(72) Inventors: Linzhi Zhao, Chongqing (CN); Jianchuan Li, Chongqing (CN); Rongguan Zhou, Chongqing (CN); Jian Wang, Chongqing (CN)

(21) Appl. No.: 18/666,868

(22) Filed: May 17, 2024

Related U.S. Application Data
(63) Continuation of application No. PCT/CN2024/089392, filed on Apr. 23, 2024.

(51) Int. Cl. C03B 20/00; B24B 13/005; C03B 11/08; G02B 5/04

(52) U.S. Cl. CPC C03B 20/00; B24B 13/005; C03B 11/08; G02B 5/04; C03B 2215/46

(57) ABSTRACT

The present application provides an aspherical prism and a preparation method thereof, and the method including: S1, molding a lens and a prism integrally using a hot press molding method to obtain a molding body glass; S2, cutting the molding body glass into a strip glass; S3, performing a first grinding and a first polishing on a right-angled surface; S4, machining a curved surface structure on the right-angled surface; S5, performing a second polishing on the machined curved surface structure; S6, machining an reflective surface; S7, chamfering edges of the strip glass; S8, coating the strip glass after being chamfering; and S9, cutting the coated strip glass into individual aspherical prisms. The preparation method can not only process a plurality of aspherical prisms at one time, but also reduces the preparation cycle, improves processing efficiency, and minimizes dimensional fluctuations to achieve uniformity.

### CROSS-REFERENCE TO RELATED APPLICATIONS

This application is a continuation of International Application No. PCT/CN2024/089392, filed Apr. 23, 2024, the entire contents of which are incorporated herein by reference.

### TECHNICAL FIELD

The present application relates to the field of optical technologies, in particular to an aspherical prism and a preparation method thereof.

### BACKGROUND

The three-in-one prism is mainly formed by combining a lens (spherical convex lens or concave lens) and a prism.

In the preparation of the three-in-one prism, when assembling the lens and the prism, different specifications of the three-in-one prism can choose different specifications of lenses and prisms for assembly. The assembly method mainly involves bonding the lens and the prism together using adhesive. In the assembly process of optical lenses, support brackets can be used to achieve assembly. However, whether using adhesive bonding or support bracket assembly, there are very high requirements for the fit clearance between the lens and the prism, the precision of components, and the assembly accuracy.

In the related art, the lenses and prisms of the three-in-one prism are processed separately using different equipment. Processes such as grinding, polishing, chamfering, coating, and ink application are carried out individually on optical equipment. This results in a long preparation cycle, low machining efficiency, and large fluctuations in dimensional accuracy, making it difficult to achieve uniformity in the production of three-in-one prisms.

### SUMMARY

An object of the present application is to provide a preparation method of an aspherical prism to solve the problem that the preparation method of a three-in-one prism in the related art leads to a long preparation cycle, low machining efficiency, and large fluctuations in dimensional accuracy, making it difficult to achieve uniformity.

In order to solve the above problems, in a first aspect, the present application provides a preparation method of an aspherical prism, comprising the following steps:
S1, molding a lens configured to form an incident surface and a prism integrally using a hot press molding method to obtain a molding body glass;
S2, cutting the molding body glass into a strip glass;
S3, bonding the strip glass to a workpiece and performing a first grinding and a first polishing on a right-angled surface according to a predetermined size; wherein a machining volume for the first polishing is reserved after the first grinding;
S4, machining a curved surface structure on the right-angled surface after the first polishing, and reserving a machining volume for a second polishing;
S5, performing the second polishing on the machined curved surface structure;
S6, turning the strip glass after the second polishing over, bonding the strip glass to the workpiece again, and machining a reflective surface;
S7, chamfering edges of the strip glass after machining the reflective surface;
S8, coating the strip glass after being chamfering;
S9, cutting the coated strip glass into individual aspherical prisms; and
S10, applying ink to the aspherical prisms.

In one embodiment, in the step S1, a whole-row mold is used for hot press molding, and the molding body glass has a spherical structure or an aspherical structure.

In one embodiment, in the step S2, laser cutting or wire cutting is used for cutting, and a machining allowance of one side of the strip glass is more than 0.3 mm.

In one embodiment, in the step S3, after bonding the strip glass to the workpiece using two opposite surfaces of the strip glass as datum planes, centers of all spherical structures or aspherical structures on the same strip glass are on a horizontal line; an angular tolerance of the workpiece is less than 1 decimeter; and the machining volume reserved for the first polishing is greater than 20 μm.

In one embodiment, in the step S4, the curved surface structure is any one of a spherical structure, an aspherical structure, and a free curved surface structure; a computer numerical control machine is used for machining the curved surface structure; an eccentricity of the curved surface structure is made to less than 10 μm by using a mechanical positioning method; and the machining volume reserved for the second polishing is greater than 5 μm.

In one embodiment, in the step S5, the second polishing is carried out by using an upward swinging machine or a downward swinging machine, so as to enable the curved surface structure to achieve a desired face shape, sagittal height, and roughness.

In one embodiment, in the step S6, centers of a spherical structure or an aspherical structure on an incident surface of the strip glass are in the same horizontal plane after bonding the strip glass to the workpiece using the incident surface and the right-angled surface of the strip glass as datum planes.

In one embodiment, in the step S6, machining the reflective surface comprises the following steps:
S61, grinding the reflective surface of the strip glass bonded to the workpiece;
S62, performing a second grinding on the reflective surface after grinding, and reserving a machining volume for a third polishing; wherein the machining volume reserved for the third polishing is greater than 20 um;
S63, performing the third polishing on the reflective surface after the second grinding and completing the machining of the reflective surface.

In one embodiment, in the step S8, coating the strip glass after being chamfering is performed by: coating an anti-reflective film on the incident surface and the right-angled surface, and coating a high reflective film on the reflective surface.

In one embodiment, in the step S10, applying ink to the aspherical prism is performed by: applying ink to an outside of a light-through aperture of the incident surface and the right-angle surface of the aspherical prism by means of pad-printing, and applying ink to side surfaces and chamfers of the aspherical prism by means of screen-printing.

In a second aspect, the present application provides an aspherical prism comprising an incident surface and a right-angle surface which are perpendicular to each other, and a reflective surface connecting the incident surface and the right-angle surface, wherein at least one of the incident surface and the right-angle surface is of an aspherical structure; wherein the aspherical prism is manufactured using the above-mentioned preparation method of the aspherical prism.

Compared with the related art, the preparation method of the aspherical prism in the present application integrally molds the lens and the prism by the hot press molding method. This allows subsequent processes such as grinding, polishing, chamfering, coating, and ink application to be based on the same datum, enabling simultaneous processing of multiple aspherical prisms in a single operation. It also reduces the preparation cycle, improves processing efficiency, and minimizes dimensional fluctuations to achieve uniformity. Additionally, the hot-press molding facilitates integrated processing in subsequent stages, eliminating assembly errors, and enhancing the structural accuracy of aspherical prisms.

### BRIEF DESCRIPTION OF DRAWINGS

In order to more clearly illustrate the technical solutions in the embodiments of the present application, the accompanying drawings to be used in the description of the embodiments will be briefly introduced below. Obviously, the accompanying drawings in the following description are only some embodiments of the present application, and for the person of ordinary skill in the field, other accompanying drawings can be obtained based on these drawings without putting forth any creative labor.

FIG. 1 shows a flowchart of a preparation method of an aspherical prism according to an embodiment of the present application.

FIG. 2 is a structural schematic diagram of an array molding body glass in step S1 in the preparation method of the aspherical prism according to an embodiment of the present application.

FIG. 3 is a structural schematic diagram of a strip glass after being mounted to a workpiece in step S6 in the preparation method of the aspherical prism according to an embodiment of the present application.

FIG. 4 is a structural schematic diagram of the strip glass after being chamfered in step S7 in the preparation method of the aspherical prism according to an embodiment of the present application.

FIG. 5 is a schematic diagram of the aspherical prism from a first view angle according to an embodiment of the present application.

FIG. 6 is a schematic diagram of the aspherical prism from a second view angle according to an embodiment of the present application.

### DETAILED DESCRIPTION OF THE EMBODIMENTS

The technical solutions in the embodiments of the present application will be described clearly and completely in the following in conjunction with the accompanying drawings in the embodiments of the present application. Obviously, the described embodiments are only a part of the embodiments of the present application and not all of the embodiments. Based on the embodiments in the present application, all other embodiments obtained by a person of ordinary skill in the art without making creative labor fall within the protection scope of the present application.

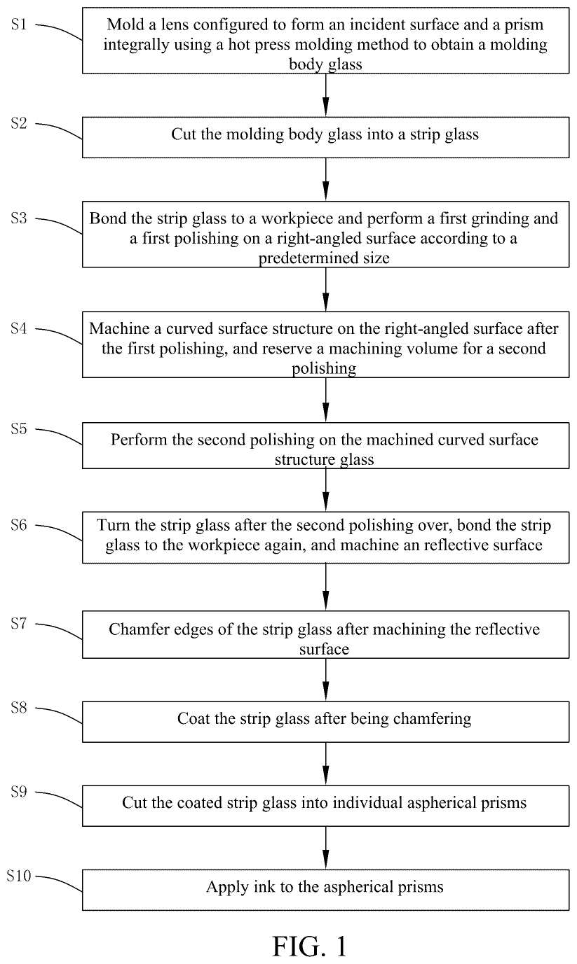

As shown in conjunction with FIG. 1, embodiments of the present application provide a preparation method of an aspherical prism, comprising the following steps.

S1, a lens configured to form an incident surface and a prism are molded integrally using a hot press molding method to obtain a molding body glass.

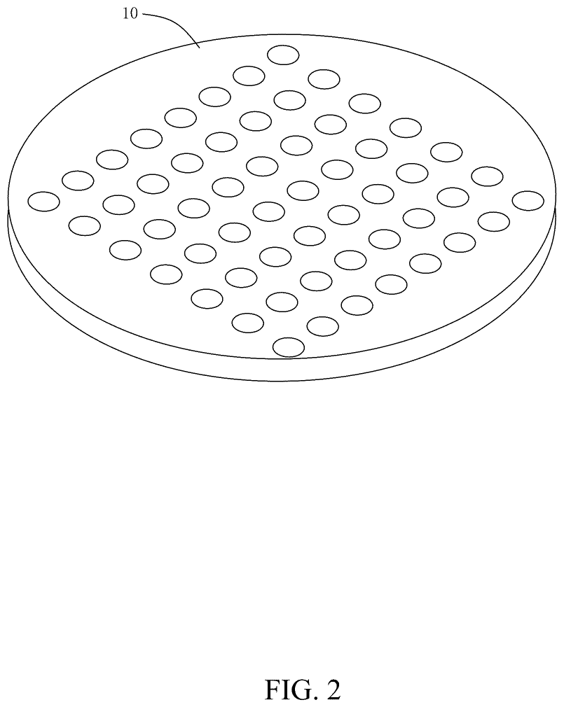

The hot press molding is carried out using a precision-machined whole-row mold to mold flat glass (wafer) after polishing on both sides into an array molding body glass 10 (as shown in FIG. 2) with an aspherical structure (or a spherical structure), and it is ensured that a warping of the forming body glass is less than 10 μm, a core thickness is in the range of ±10 μm, a face shape of the aspherical structure is less than 300 nm, and a sagittal height is in the range of ±1 μm.

S2, the molding body glass is cut into strips of glass.

The cutting is carried out by means of laser cutting (or wire cutting), and a machining allowance of one side of the strip glass is more than 0.3 mm.

S3, the strip glass is bonded to a workpiece and a first grinding and a first polishing are performed on a right-angled surface according to a predetermined size.

A double-sided grinding machine is used to grind the strip glass bonded (glued) to the workpiece, and the size and roughness of the grinding and the surface finish of the strip glass are strictly monitored in the grinding process.

After the first grinding, the machining volume of the first polishing is reserved, which is more than 20 μm.

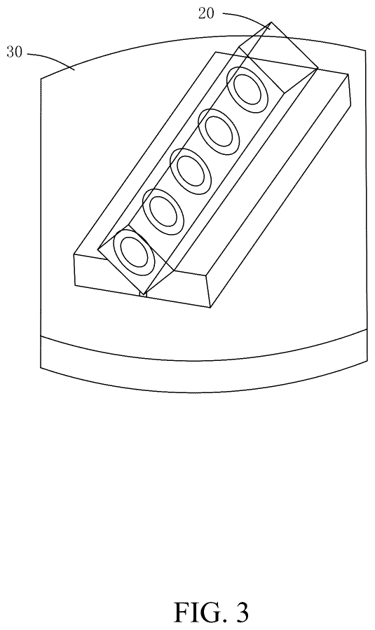

As shown in FIG. 3, after the strip glass 20 is bonded to the workpiece 30 with two opposite surfaces (or upper and lower surfaces) of the strip glass 20 as the datum planes, centers of all spherical structures or aspherical structures on the same strip glass 20 are on a horizontal line, and a height falloff is less than 5 μm. An angular tolerance of the workpiece 30 is less than 1 decimeter.

S4, a curved surface structure is machined on the right-angled surface after the first polishing, and a machining volume for a second polishing is reserved.

The curved surface structure is any one of a spherical structure, an aspherical structure, or a free curved surface structure.

A computer numerical control machine is used to machine the curved surface structure. Specifically, the strip glass is fixed on a table of the three-axis computer numerical control machine, and then the spherical surface structure is machined. The face shape and position of the spherical surface structure are strictly monitored during the machining to ensure that an eccentricity of the spherical surface structure is less than 10 μm by using a mechanical positioning method.

The machining volume reserved for the second polishing is greater than 5 μm.

S5, the second polishing is performed on the machined curved surface structure.

A downward swinging machine (or an upper swinging machine) is used to carry out the second polishing, so as to enable the curved surface structure to achieve the desired face shape, sagittal height, and roughness, and the face shape, roughness, and finish of the spherical surface structure are strictly monitored during the polishing.

S6, the strip glass after the second polishing is turned over, the strip glass is bonded to the workpiece again, and a reflective surface is machined.

As shown in FIG. 3, the centers of the spherical structure or the aspherical structure on the incident surface or the aspherical structure of the strip glass 20 are on the same horizontal plane after the strip glass 20 is bonded to the workpiece 30 using the incident surface and the right-angle surface of the strip glass 20 as the datum planes. Besides, the workpiece 30 avoids the optical surface at the incident surface and the right-angle surface, so as to ensure that the bonding and the subsequent degumming process will not damage the optical surface.

The machining of the reflective surface includes the following steps.

S61, the reflective surface of the strip glass bonded to the workpiece is ground.

The grinding is performed using a grinding machine to remove excess material.

S62, a second grinding is performed on the reflective surface after grinding, and a machining volume for a third polishing is reserved.

The machining amount reserved for the third polishing is greater than 20 μm.

S63, the reflective surface after the second grinding is performed the third polishing, and the machining of the reflective surface is completed.

A polishing machine is used to polish the reflective surface to form a lens surface, and its face shape, roughness, and finish of the reflective surface are strictly monitored during the polishing, and it ensures that the tolerance of the face shape is λ/20.

S7, edges of the strip glass after machining the reflective surface are chamfered.

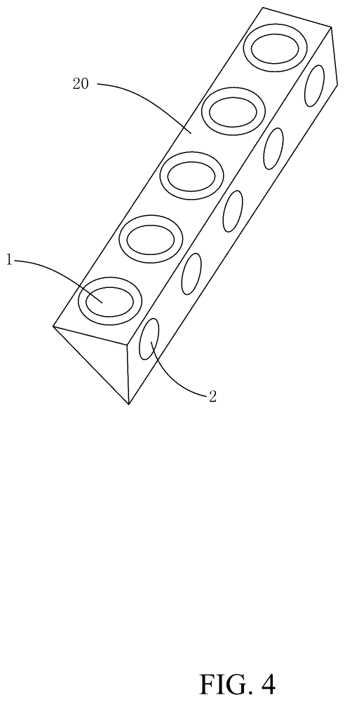

A chamfering machine is used to perform the chamfering process, and the size of the chamfering and chipping data are strictly monitored during the process. The strip glass 20 after the chamfering process is completed is shown in FIG. 4, which includes a plurality of incident surfaces 1 and a plurality of reflective surfaces 2.

S8, the strip glass after being chamfering is coated.

The coating of the strip glass after being chamfering is as follows: an anti-reflective film (AR film) is coated on the incident surfaces and the right-angled surfaces, and a high reflective film (HR film) is coated on the reflective surfaces.

The incident surface, right-angled surface, and the reflective surface are coated using an evaporation method, and the thickness of the coating layer and the reflectivity after coating need to be strictly monitored during the coating process.

S9, the coated strip glass is cut into individual aspherical prisms.

Laser cutting (or wire cutting) is used for cutting, and the perpendicularity and dimensional data are strictly monitored during the cutting process.

S10, the aspherical prism is subject to ink application.

Applying ink to the aspherical prism is as follows: applying ink to the outside of a light-through aperture of the incident surface and the right-angle surface of the aspherical prism by means of pad-printing, and applying ink to side surfaces and chamfers of the aspherical prism by means of screen-printing. The range of the inking, the thickness of the ink layer, and the situation of under-inking and over-inking are strictly monitored during the inking process, and the transmittance and reflectance are monitored after the inking process.

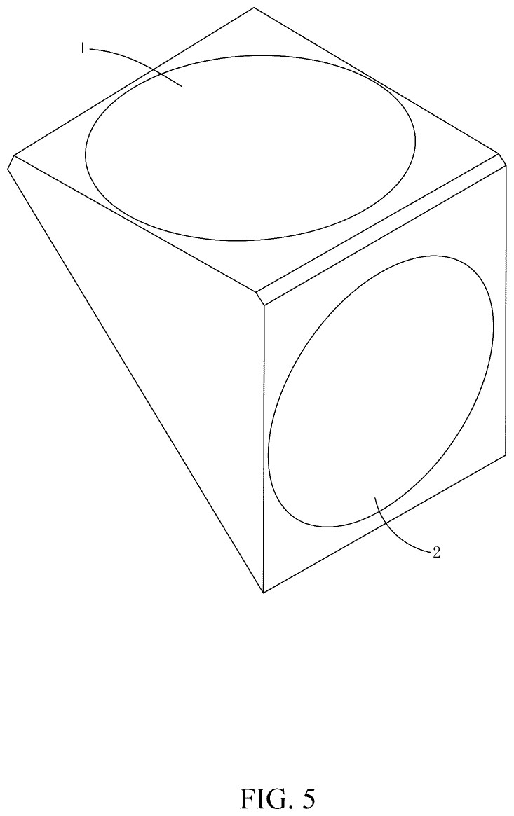

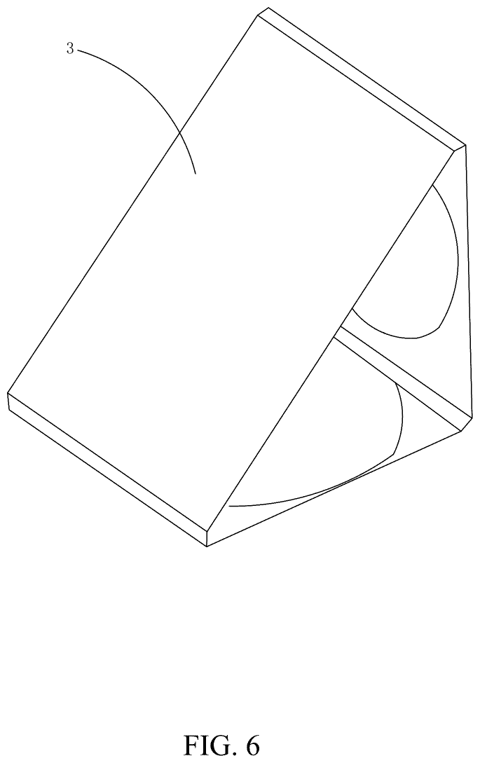

The aspherical prism after the inking is completed is shown in FIGS. 5 and 6, which includes mutually perpendicular incident surface 1 and right-angle surface 2, and a reflective surface 3 connecting the incident surface 1 and the right-angle surface 2, wherein at least one of the incident surface 1 and the right-angle surface 2 is an aspherical structure, and, of course, according to the actual needs, the right-angle surface 2 can also be an aspherical structure, based on the above method steps, it is possible to realize that the right-angle surface 1 and the right-angle surface 2 are aspherical structures. 2 is an aspherical structure.

The preparation method of the aspherical prism in this embodiment integrally molds the lens and the prism by the hot press molding method. This allows subsequent processes such as grinding, polishing, chamfering, coating, and ink application to be based on the same datum, enabling simultaneous processing of multiple aspherical prisms in a single operation. It also reduces the preparation cycle, improves processing efficiency, and minimizes dimensional fluctuations to achieve uniformity. Additionally, the hot-press molding facilitates integrated processing in subsequent stages, eliminating assembly errors, and enhancing the structural accuracy of aspherical prisms.

Described above are only embodiments of the present application, and it should be pointed out that, for the ordinary technical personnel in the field, improvements can also be made without departing from the premise of the concept of the present application, but these are all within the protection scope of the present application.

What is claimed is:

1. A preparation method of an aspherical prism, comprising the following steps:
S1, molding a lens configured to form an incident surface and a prism integrally using a hot press molding method to obtain a molding body glass;
S2, cutting the molding body glass into a strip glass;
S3, bonding the strip glass to a workpiece and performing a first grinding and a first polishing on a right-angled surface according to a predetermined size; wherein a machining volume for the first polishing is reserved after the first grinding;
S4, machining a curved surface structure on the right-angled surface after the first polishing, and reserving a machining volume for a second polishing;
S5, performing the second polishing on the machined curved surface structure;
S6, turning the strip glass after the second polishing over, bonding the strip glass to the workpiece again, and machining a reflective surface;
S7, chamfering edges of the strip glass after machining the reflective surface;
S8, coating the strip glass after being chamfering;
S9, cutting the coated strip glass into individual aspherical prisms; and
S10, applying ink to the aspherical prisms.

2. The preparation method of claim 1, wherein in the step S1, a whole-row mold is used for hot press molding, and the molding body glass has a spherical structure or an aspherical structure.

3. The preparation method of claim 1, wherein in the step S2, laser cutting or wire cutting is used for cutting, and a machining allowance of one side of the strip glass is more than 0.3 mm.

4. The preparation method of claim 2, wherein in the step S3, after bonding the strip glass to the workpiece using two opposite surfaces of the strip glass as datum planes, centers of all spherical structures or aspherical structures on the same strip glass are on a horizontal line; an angular tolerance of the workpiece is less than 1 decimeter; and the machining volume reserved for the first polishing is greater than 20 μm.

5. The preparation method of claim 1, wherein in the step S4, the curved surface structure is any one of a spherical structure, an aspherical structure, and a free curved surface structure; a computer numerical control machine is used for machining the curved surface structure; an eccentricity of the curved surface structure is made to less than 10 μm by using a mechanical positioning method; and the machining volume reserved for the second polishing is greater than 5 μm.

6. The preparation method of claim 1, wherein in the step S5, the second polishing is carried out by using an upward swinging machine or a downward swinging machine, so as to enable the curved surface structure to achieve a desired face shape, sagittal height, and roughness.

7. The preparation method of claim 2, wherein in the step S6, centers of a spherical structure or an aspherical structure on an incident surface of the strip glass are in the same horizontal plane after bonding the strip glass to the workpiece using the incident surface and the right-angled surface of the strip glass as datum planes.

8. The preparation method of claim 1, wherein in the step S6, machining the reflective surface comprises the following steps:
S61, grinding the reflective surface of the strip glass bonded to the workpiece;
S62, performing a second grinding on the reflective surface after grinding, and reserving a machining volume for a third polishing; wherein the machining volume reserved for the third polishing is greater than 20 μm;
S63, performing the third polishing on the reflective surface after the second grinding and completing the machining of the reflective surface.

9. The preparation method of claim 1, wherein in the step S8, coating the strip glass after being chamfering is performed by: coating an anti-reflective film on the incident surface and the right-angled surface, and coating a high reflective film on the reflective surface.

10. The preparation method of claim 1, wherein in the step S10, applying ink to the aspherical prism is performed by: applying ink to an outside of a light-through aperture of the incident surface and the right-angle surface of the aspherical prism by means of pad-printing, and applying ink to side surfaces and chamfers of the aspherical prism by means of screen-printing.

11. An aspherical prism, comprising an incident surface and a right-angle surface which are perpendicular to each other, and a reflective surface connecting the incident surface and the right-angle surface, wherein at least one of the incident surface and the right-angle surface is of an aspherical structure; wherein the aspherical prism is manufactured using a preparation method of claim 1.
